(19) United States
(12) Patent Application Publication
(10) Pub. No.: US 2014/0062490 A1
(43) Pub. Date: Mar. 6, 2014

(54) CATHODIC PROTECTION MONITORING METHOD, SYSTEM AND COMPONENTS

(71) Applicants: Michael Alexander St Leger NEUMAN, Warrawee (AU); John Richard HADDY, Lane Cove West (AU); David Edward ROBERTSON, Belair (AU); Robert Leslie COX, Bundoora (AU)

(72) Inventors: Michael Alexander St Leger NEUMAN, Warrawee (AU); John Richard HADDY, Lane Cove West (AU); David Edward ROBERTSON, Belair (AU); Robert Leslie COX, Bundoora (AU)

(21) Appl. No.: 13/802,072

(22) Filed: Mar. 13, 2013

Related U.S. Application Data
(60) Provisional application No. 61/621,282, filed on Apr. 6, 2012.

(51) Int. Cl. G01V 3/02

(52) U.S. Cl. CPC G01V 3/02
USPC 324/347

(57) ABSTRACT

Cathodic protection (CP) monitoring methods, systems and system components that provide regular (typically daily or more frequent) potential data collection for accurate assessment of CP systems. The methods, systems and components of the invention are used for remote monitoring of passive sacrificial anode CP systems and more particularly for monitoring of CP protection for buried storage tanks. These systems have on-site components for collection of data and transmission of data to remote databases and can employ computer-implemented and/or system operator assessed data processing and interpretation of data to assess protection status of a given structure and further to generate appropriate reports of protection status and collected and processed data.

### CROSS-REFERENCE TO RELATED APPLICATIONS

This application claims the benefit of U.S. provisional application 61/621,282, filed Apr. 6, 2012, which application is incorporated by reference herein in its entirety.

### BACKGROUND OF THE INVENTION

Underground metal structures, particularly steel structures, including storage tanks, pipes and construction support members, are subject to electrochemical corrosion. The soil in which the structures are buried is an electrolyte and the structures in contact with this electrolyte act as an electrode. In addition to the use of anti-corrosion coating, cathodic protection (CP) is often used to inhibit or prevent electrochemical corrosion.

Cathodic protection systems function by connecting an anode to the metal structure to be protected and generating an electrical current such that the metal structure becomes a cathode and is protected from corrosion. CP systems include passive, sacrificial anode systems or active, impressed current systems. In a sacrificial anode system, the electrical current results from the potential difference between the metal of the sacrificial anode and the metal of the structure. For protection of steel structures, sacrificial anodes of aluminum, zinc, or more particularly, magnesium (or alloys thereof) are employed. In an impressed current system an external dc power supply connected through inert anodes provides the current.

CP systems are typically periodically monitored to assess the adequacy of cathodic protection. Conventional monitoring of such sacrificial anode systems involves periodic (typically annual) site visits by a trained technician to take voltage measurement with respect to a reference electrode (conventionally a portable Cu/CuSO₄ reference). Such measurements do not require calibration and allow the use of a universally accepted cut off voltage (−850 mV with respect to a Cu/CuSO₄ reference) as a standard for reliable prediction that the structure will remain properly protected until the next site visit. However, conventional monitoring based on periodic site visits is costly.

Conventional manual monitoring of cathodic protection systems normally requires disconnection of the anodes from the metal structure, interrupting protection. Additionally, failure to reconnect the anodes after monitoring results in unintended loss of cathodic protection. To avoid interruption of cathodic protection for monitoring, systems employing a coupon representative of the metal structure have been developed. The coupon is positioned underground in the vicinity of and electrically connected to the metal structure. In such systems, protection is monitored by disconnecting the coupon from the metal structure and measuring the voltage at the coupon with respect to a reference electrode (Eoff).

A number of CP monitoring systems have been described, including those which provide for remote monitoring. U.S. Pat. Nos. 3,351,545; 5,144,247; 5,469,048; 5,814,982; 5,999,107; 6,107,811; 6,160,403, 7,459,067 and 8,030,951 relate to CP monitoring systems and each is incorporated by reference herein in its entirety for descriptions of CP systems and CP monitoring systems. However, there remains a significant need in the art for low-installation and low-operation cost CP monitoring systems that also provide accurate and timely assessment of the level of protection provided by such systems.

### SUMMARY OF THE INVENTION

The present invention provides CP monitoring methods, systems and system components that provide regular (typically daily or more frequent) potential data collection which allows accurate assessment of CP systems. The methods, systems and system components of the invention provide low cost monitoring over CP system lifetime and reliable, remote monitoring of CP systems. The methods, systems and components of the invention are particularly useful for monitoring of passive sacrificial anode CP systems and more particularly for monitoring of CP systems used to protect buried storage tanks (e.g., buried liquid propane storage tanks).

The CP monitoring system of this invention comprises on-site components for collection of potential data and transmission of the data to a remote database and in specific embodiments comprises computer-implemented and/or system operator assessed data processing and interpretation of data to assess protection status of a given structure and further to generate appropriate reports of protection status and collected and processed data. The CP monitoring system of this invention is based on measurement of the potential difference between a coupon and a reference electrode installed at the CP site and use of such collected data to assess protection state of a protected structure.

On-site components of the CP system of this invention employ an integrated coupon/in situ reference electrode element, preferably in the form of a stake, which can be readily and quickly installed at the CP site, preferably manually, such that a coupon and in situ reference electrode therein are appropriately positioned underground with respect to the buried structure. In a specific embodiment, the coupon and in situ reference electrode are positioned within the stake at a selected distance from each other. The reference electrode employed is durable, reliable and stable over a CP system lifetime. Preferably a zinc reference electrode is employed. In a specific embodiment, the stake is sized (length and diameter) for ease of installation and proper location of coupon and reference electrode with respect to the buried structure. On-site components further comprise a potential measurement device, an associated control unit and communications interface which collectively provide for selectively scheduled potential difference measurements, averaging of such measurements, local storage of averaged measurements and selectively scheduling of transmission of collected data to a remote database.

Collected potential difference data is stored in the remote database along with associated protected structure information and optionally manual potential measurements taken on site. The collected data is employed to assess protection status of a given structure (e.g., a storage tank) by its CP system. Protection status of a given protected structure is determined by a comparison of collected data with respect to pre-set potential limits known (or determined) to be indicative of protection status. In a specific embodiment, four protection states are described: protected, unprotected, marginally protected and overprotected based on comparison of collected data with pre-set potential limits. Protection state of a given protected structure can be assessed at any selected time automatically by a computer-implemented process. In a preferred embodiment, any automated assessment of protection state or any change in protection state is reviewed and confirmed by a skilled/trained operator. In specific embodiments, the collected data is smoothed and calibrated with respect to a Cu/CuSO₄ reference electrode prior to protection status assessment with respect to this conventional standard. In a specific embodiment, the collected data is reviewed for a period of time after installation of the on-site measurement components to determine that the potential difference measurements have stabilized. Assessment of data stabilization can be made automatically by a computer-implemented process or currently more preferred, by a skilled/trained operator.

Protection status reports can be generated in any convenient form for one or more structures based on assessment and interpretation of collected data. The system can also generate alarms triggered by the occurrence of pre-selected events which affect protection state, operation of a monitored CP system or operation of the CP monitoring system itself. Such alarms can be reported to system operators and/or customers by any appropriate communication method consistent with the level of urgency of action that should be taken in view of the reported alarm.

In a specific embodiment, the CP monitoring system generates a summary report, preferably in graphic form, of protection status of one or more protected structures. In a specific embodiment, the CP monitoring system generates reports, preferably in graphic form, which show variation in raw collected and/or smoothed and/or calibrated potential difference data for a given protected structure as a function of time. Such reports optionally, but preferably, also provide indications of the potential limits associated with protection state. Such reports optionally, but preferably, also provide an assessment of the reliability of the protection state determinations by a skilled/trained operator. In a specific embodiment, the CP monitoring system can generate and store a log of events with respect to data processing or interpretation, which can include a log of any protection state changes and any alarms generated for a given CP system or selected set of CP systems.

In a specific embodiment, the CP system of this invention provides a customer interface for on-demand access to collected data, smoothed data, assessed protection states of customer owned (or managed) protected structures, associated information on the protected structure and various reports generated by the system. In a preferred embodiment, the interface is implemented via security-controlled internet access to the collected and processed data and reports. For a given customer, the interface can provide a summary of protection state of all or any selected subset of protected structures associated with the customer. In addition, the interface provides access to collected or processed data of any given protected structure along with any associated information on the protected structure, its CP system and the installed CP monitoring system.

In an embodiment, the invention provides a method for monitoring the effectiveness of protection provided to an underground structure by a CP system employing the CP monitoring system as described herein. More specifically, the method includes positioning of a metal coupon and an in situ reference electrode underground at a predetermined position with respect to structure, wherein the metal coupon, the in situ reference electrode with appropriate electrical connections are integrated into a stake for ease of installation, proper positioning of the coupon with respect to the structure and to allow proper electrical connection of the coupon to the structure. The method further includes measurement of the potential difference between the coupon and in situ reference electrode when the coupon is electrically disconnected from the structure (Eoff). In an embodiment, power is supplied for taking a potential difference measurement only when the coupon is disconnected from the structure. In an alternative embodiment, the on-site components of the system are configured to allow a potential difference measurement when the coupon is connected (Eon) or disconnected (Eoff) from the structure. In specific embodiments, potential difference data sampling is configured to attenuate 50 Hz noise, 60 Hz noise or both by 60 dB or more. In another specific embodiment, potential difference is measured after passage of the voltage output through a low pass filter.

Periodic data measurements are performed on a selected schedule (e.g., daily). Collected data are transmitted typically on a selected schedule (e.g., weekly) to a central database and in a specific embodiment collected data is smoothed and/or calibrated with respect to a standard Cu/CuSO₄ reference electrode. Additionally, after installation of the coupon and in situ reference electrode, collected data is assessed for stabilization of these installed components. Stabilized collected data which may be smoothed and calibrated is employed to assess protection status of the protected structure on a continuing basis. Data assessment and interpretation can be implemented by a computer-controlled process and/or by assessment by a skilled/trained operator. The method of the invention optionally includes the generation of reports of protection status in any appropriate format that is convenient or useful. In a specific embodiment, access to data and reports is provided to customers via an internet-based interface.

Other aspects and embodiments of the invention will be readily apparent on review of the drawings and detailed description which follow.

### BRIEF DESCRIPTION OF THE DRAWINGS

FIG. 1A illustrates on-site components of an exemplary cathodic protection monitoring system of this invention.

FIG. 1B schematically illustrates an exemplary control unit of a cathodic protection monitoring system of this invention.

FIGS. 2 A-C illustrate an exemplary stake of this invention having stake assembly inserted into a hollow, mechanically-protective and electrically-insulating tube with dual electrical cables providing connection to a potential measurement device. FIG. 2A illustrates an exploded view of the stake assembly. FIG. 2B illustrates the detail of the hollow, mechanically-protective and electrically-insulating tube of the stake. FIG. 2C illustrates detail of the dual electrical cable.

FIG. 2D illustrates an alternative embodiment of the stake where the coupon is a separate element from the driving tip.

FIGS. 3A-C provide further detailed illustration of a stake. FIG. 3A illustrates the outside of the constructed stake ready for insertion into the ground. A number of functional holes are provided in the tube. FIG. 3B illustrates the interior of the stake with the stake assembly inserted. FIG. 3C illustrates a positioning pin in the tube of the stake.

FIGS. 4A and B illustrate more detail of an exemplary stake assembly with the reference electrode supported in an upper and lower bulkhead. FIG. 4A illustrates the insertion of the reference electrode into the bulkhead supports. FIG. 4B illustrates the reference electrode inserted into the bulkheads.

FIGS. 5A-E illustrate in more detail the upper and lower bulkheads of the stake assembly. FIGS. 5A and 5B illustrate detail of the upper bulkhead. FIGS. 5C and D illustrate details of the lower bulkhead. FIG. 5E illustrates the lower bulkhead in place within the stake assembly tube.

FIGS. 6A and B illustrate additional details of an exemplary stake assembly of this invention. FIG. 6A illustrates additional details of electrical connection within the assembly. FIG. 6B illustrates additional details of the dual connector of the stake.

FIGS. 7A-7C illustrate threading and securing of a securing cord through the upper bulkhead and the lower bulkhead of the stake assembly. FIG. 7A illustrates threading of securing cord and FIG. 7B illustrates tightening and securing of the securing cord in the cable slot of the upper bulkhead. FIG. 7C illustrates securing of the securing cord in the lower bulkhead.

FIGS. 8A-8C illustrate a stake driver for positioning and installation of the stake at a selected depth underground. FIG. 8A illustrates the driver. FIG. 8B illustrates insertion of the dual cable in the driver for installation of the stake. FIG. 8C illustrates the combined stake and driver.

FIG. 9 is a flow chart illustrating additional embodiments of the CP system and methods of this invention. The left side of the flow chart represents steps that take place at the site of the CP system. The right side of the flow chart represents remote system components and steps that take place at one or more remote locations.

FIG. 10 illustrates an exemplary graphical report which provides an overview of protection state of a plurality of protected structures.

FIG. 11 Illustrates a historical graph of collected data as a function of time that can be generated by the CP monitoring system.

### DETAILED DESCRIPTION OF THE INVENTION

The Invention is further described by reference to the drawings wherein the same numbers represent the same elements.

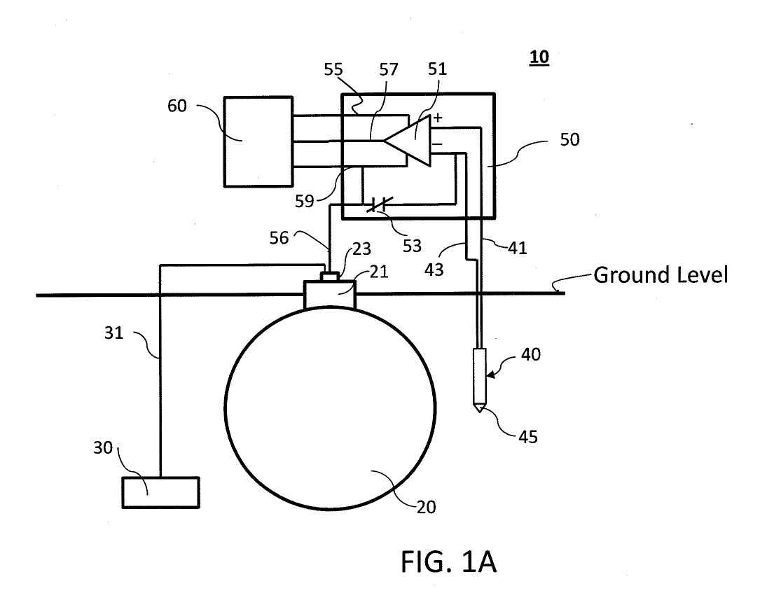

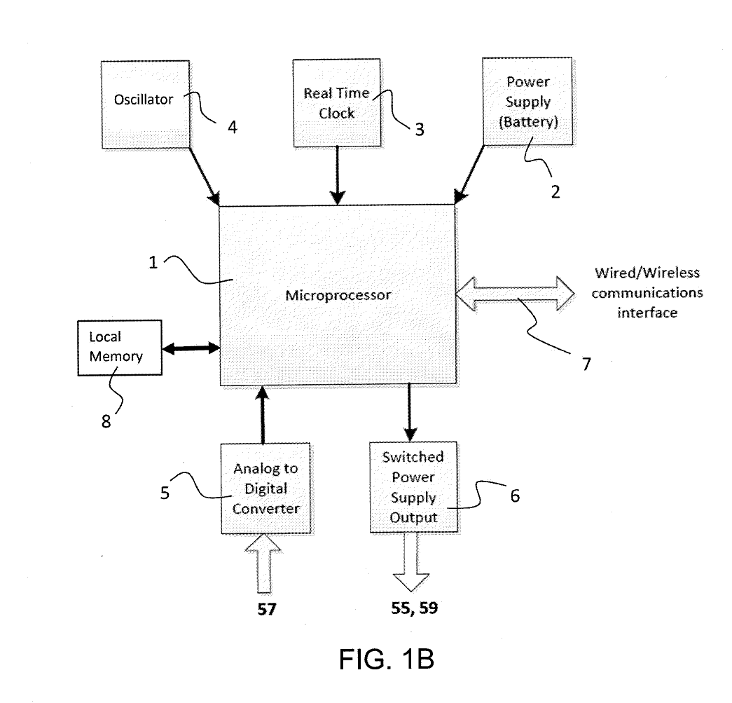

FIG. 1A illustrates on-site components of an exemplary cathodic protection monitoring system 10 of this invention. The system as illustrated is implemented wherein the structure to be protected is a metal underground storage tank 20 with turret 21 and bus bar 23 electrically connected (via insulated electrical cable 31) to a sacrificial anode 30. The monitoring system comprises stake 40, which carries a coupon 46, a reference electrode 47, and electrical cable for connection as described below; a potential measurement device 50; and a control unit 60 which provides for wired/wireless communication as discussed below.

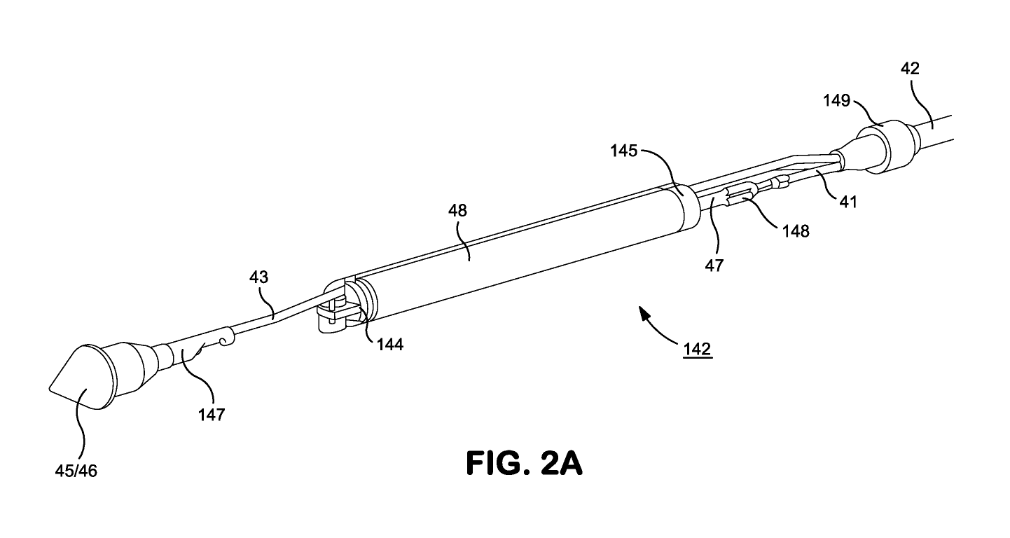

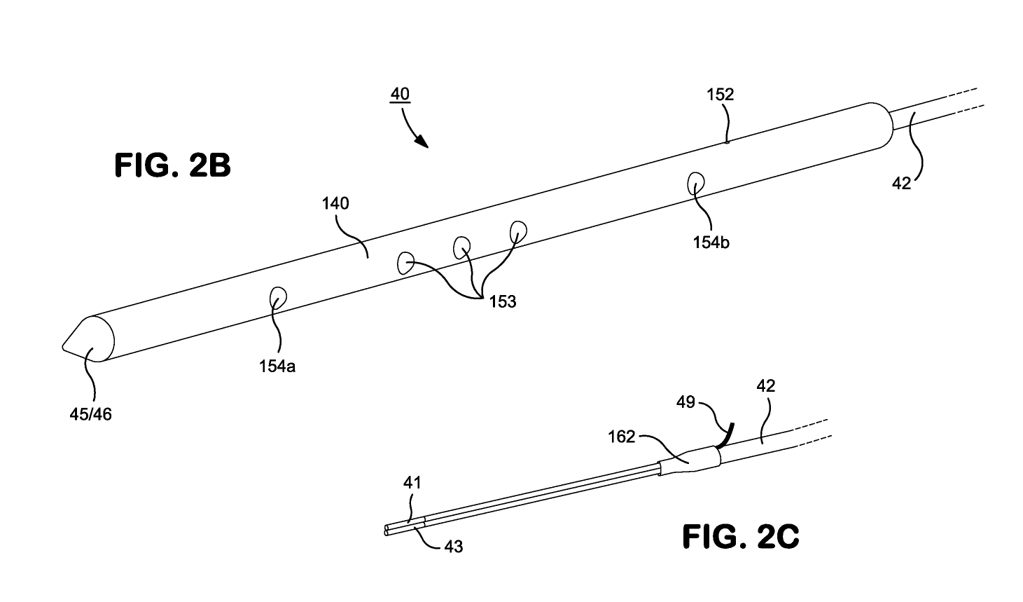

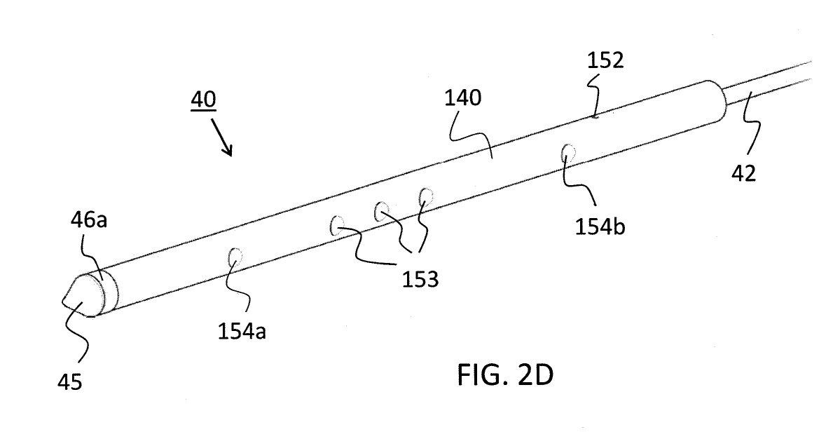

The stake has driving tip 45 to facilitate driving the stake into the ground. The stake comprises a coupon 46 and a reference electrode 47 (illustrated in more detail in FIGS. 2-7) which are integrated into the stake and insulated from each other therein. In the illustrated embodiments, the metal coupon 46 is at least a portion of the driving tip 45. In an alternative embodiment, illustrated in FIG. 2D, the coupon 46a is provided as a separate element (e.g., a collar) from driving tip 45. In this embodiment, the driving tip can be made of any suitable material and preferably is made of a non-metal material. The coupon 46 is positioned in the stake 40 to be in contact with the surrounding soil and is selectively electrically connected to tank 20 via insulated cable 43, switch or relay contact 53, structure connection 56, and bus bar 23 to tank 20. Relay switch 53 is in the normally closed configuration connecting the tank (20) to coupon 46. The coupon 46 is also electrically connected via insulated cable 43 to potential measuring device 50. The reference electrode 47 is in contact with the surrounding soil and is electrically connected via insulated cable 41 to potential measuring device 50. Coupon 46 and reference electrode 47 are positioned a selected distance from each other. The data output of the potential measurement device 50 is stored locally, e.g. in the memory [8] of control unit [60] and/or transmitted to a remote location e.g., via the communication interface [7] of the control unit [60].

As is conventional in the art, the coupon in a cathodic protection system is intended to simulate uncoated portions of the buried metal structure that is being protected. The coupon material is thus matched to the uncoated base material of the structure. In applications to buried storage tanks, particularly buried propane tanks, the coupon is preferably made of mild steel. Coupon material appropriate for other applications can be readily selected by one of ordinary skill in the art. The coupon is located, as known in the art, so that it is subject to the same soil conditions as the buried structure and to the same cathodic protection as the structure. The coupon is typically sized to be similar to that of a typical coating defect (also called a holiday). Normally coupons of 1-4 cm² are employed.

Potential measuring device 50 is configured to measure the differential potential of coupon 46 with respect to the reference electrode 47. More specifically, the potential measuring device is configured to measure this potential difference, when the coupon is electrically disconnected from tank 20 (Eoff). Coupon 46 is disconnected from the tank by activation of switch 53. In a specific embodiment, the potential measurement device has >10 Mohm input impedance, >60 dB rejection at 30 Vrms 50/60 Hz and +/−10 mV accuracy.

In FIG. 1A, potential measuring device 50 and control unit 60 are illustrated as units positioned above ground. Any of the functional elements of these units may be provided separately from the other functional elements, as is convenient, so long as function is not substantially impaired. Additionally, any of the functional elements of these units may also be positioned at or below ground level, if provided with appropriate protection from soil and water.

In a specific embodiment, the system comprises control unit 60 which functions to provide power to the potential measurement device, to control the timing of taking a potential difference reading, to activate switch 53, to control delay time and sampling of the potential difference at selected intervals over a selected sampling time after such activation, to average the plurality of potential differences to obtain an average potential difference reading, and to deactivate relay switch 53, reconnecting the coupon to the tank after the taking of an average potential reading is completed. Timing the taking of a potential difference reading relates to the regular scheduling (daily, weekly etc.) of initiation of the steps for collecting an averaged potential measurement of the coupon with respect to the reference electrode. The control unit may also be configured to allow manual initiation or remote initiation of the taking of a potential difference reading. Timing of sampling of the potential difference relates to implementing a sampling regime for measuring potential difference at certain selected intervals over a selected sampling time to obtain an average potential difference reading.

In a specific embodiment, control unit 60 also functions to locally store potential difference measurements or averaged potential difference readings, if desired, and/or to transmit averaged potential difference readings to a remote location for storage or other processing. In a specific embodiment, power is applied to the potential measurement device and relay 53 only when data for an averaged potential difference reading is being taken; when power is applied the relay contact is activated to open, when power is removed the relay contact is closed.

In a specific embodiment, the potential measuring device measures an averaged potential difference between the coupon and the reference electrode which comprises averaging a plurality of potential measurements over a selected time interval and storing and/or transmitting the average measured potential difference. In a specific embodiment, control unit 60 provides for timing of potential difference measurements and averaging of the measurements. Potential difference sampling is preferably configured to attenuate 50 Hz noise, 60 Hz noise or both by 60 dB or more. In a specific embodiment, the potential difference between the metal coupon and the in situ reference electrode is measured after passage of the voltage output through a low pass filter, which can be a single pole filter providing −3 dB at 100 HZ.

In a specific embodiment, after switch 53 is activated there is a selected delay time before the potential difference is sampled to avoid inductance effects on the coupon potential after opening switch 53. In a specific embodiment, both 50 Hz and 60 Hz noise is attenuated by sampling the potential difference 30 times at 3.33 ms intervals, collecting and averaging the collected data. If the delay time before sampling is initiated is 100 ms, this exemplary sampling regime provides an averaged potential difference reading taken 150 ms after activating switch 53. It is within the skill of one of ordinary skill in the art to vary the delay time before sampling, and the sampling regime from that specifically exemplified herein without significant detriment to the quality and accuracy of the resulting averaged potential readings.

In a specific embodiment, illustrated in FIG. 1A, the potential difference measurement device is a differential input amplifier (DIA) 51, with conventional “+” and “−” inputs for connection to the coupon and the reference electrode as well as positive power supply input 55 and negative supply input 59 connected to structure connector 56. In a preferred embodiment, the DIA has an input common mode voltage range of +/−10V and a supply voltage of about +3V or less. The differential signal output voltage 57, which may be amplified, is proportional to the potential difference between the coupon 46 and the reference electrode 47. In a specific embodiment, power is supplied to the differential input amplifier 51 from control unit 60 and the output signal is input to the control unit where signal averaging is performed and data is stored and/or transmitted. When switch 53 is closed the coupon is grounded to the tank through structure connector 56. In a preferred embodiment, switch 53 is connected across the power supply such that the switch opens when the power supply is connected. In an alternative embodiment, switch 53 is controlled separately from the power supply, such that a measurement can be taken with switch 53 opened or closed which will allow measurement of Eon in addition to Eoff.

An exemplary control unit (60) is illustrated schematically in FIG. 1B. The illustrated control unit comprises one or more microprocessor 1, a suitable power supply 2, real time clock 3, oscillator circuit 4, analog to digital converter 5, switched power supply output 6, a wired or wireless communications interface 7 for transmitting (data, alarm signals, etc.) and/or receiving (system configuration data, instructions, etc.) and local memory 8 for local storage of software programs, configuration data, measurements and readings, if desired. The control unit components function together to supply power to the measurement device, activate and deactivate the relay switch, schedule the reading, and transmission or storage of potential measurements and readings, time the scheduling of potential readings, implement a selected potential difference sampling regime, average collected data and provide for remote communication. The one or more microprocessor is programmed or capable of being programmed to implement the control functions of the control unit employing components and methods that are well-known in the art. The analog to digital converter 5 receives output from the potential measurement device (e.g. output from the differential input amplifier 57) which may be stored in local memory or transmitted to a remote location. Power is supplied from switched power supply output 6 to the power supply inputs 55 and 59 to activate and deactivate switch 53 for a scheduled reading. Real time clock 3 is employed in timing the scheduling of readings and transmission of collected data as desired (e.g., hourly, daily, weekly, etc.). The oscillator circuit 4 is employed to implement the potential difference sampling regime, which in a preferred embodiment has better than ±200 ppm accuracy and ±300 ppm jitter in order to achieve the desired attenuation of noise. The control unit preferably communicates with a remote location via interface 7 transmitting averaged potential difference readings on a selected schedule. The control unit can also receive instructions from the remote location to, for example, update or change control unit configurations, change reading or transmission schedules, change the sampling regime, or trigger an unscheduled reading or data transmission.

In a specific embodiment, power supply 2 is independent of any power supply of the CP system. In a specific embodiment, the power supply is any suitable battery, particularly a lithium battery. In a specific embodiment, the power supply may be a solar battery. The control unit can be configured if desired to generate a local alarm (e.g., visible) or transmit an alarm signal to the remote location in the event an undesirable condition obtains. For example, the control unit can be configured to initiate an alarm in the event of an imminent power failure (e.g., low battery power) in the monitoring system, a fault in the CP system itself, or an averaged potential difference reading that is outside of a preset limit (not negative enough—indicating insufficient CP protection, or too negative—indicating undesirable over protection.)

FIGS. 2 A-C illustrate an exemplary stake 40 of this invention having stake assembly 142 (exploded view, FIG. 2A) inserted into hollow, mechanically-protective and electrically-insulating tube 140 (FIG. 2B) with dual electrical cable 42 (with 41 and 43 therein with detail in FIG. 2C) providing connection to the potential measurement device 50 (see FIG. 1A). The stake assembly includes coupon 46, which in the exemplified embodiment also serves as the stake driving tip 45, and reference electrode 47 integrated therein. Coupon 46 is electrically connected via electrical connector 147 to insulated cable 43 which passes along the assembly into dual cable 42 and connects to potential measuring device 50. In a specific embodiment the reference electrode is a high purity zinc strip 47 extending and supported between lower bulkhead 144 and upper bulkhead 145. In this embodiment, the zinc strip is encased in a protective electrolyte layer 48 which is porous and can absorb and retain water and the zinc strip is electrically connected via connector 148 to insulated cable 41 which exits the stake through dual cable 42 and connects to the potential measuring device. The assembly also has cable bulkhead 149 through which dual cable 42 passes and which seals the top end of the stake between the upper bulkhead and water holes 153.

FIG. 2D illustrates an alternative embodiment of the stake 40, where the coupon is a separate element from driving tip 45. The coupon is provided as a collar 46a, with appropriate electrical connection (not shown) via insulated cable similar to cable 43 and dual cable 42, to potential measuring device 50.

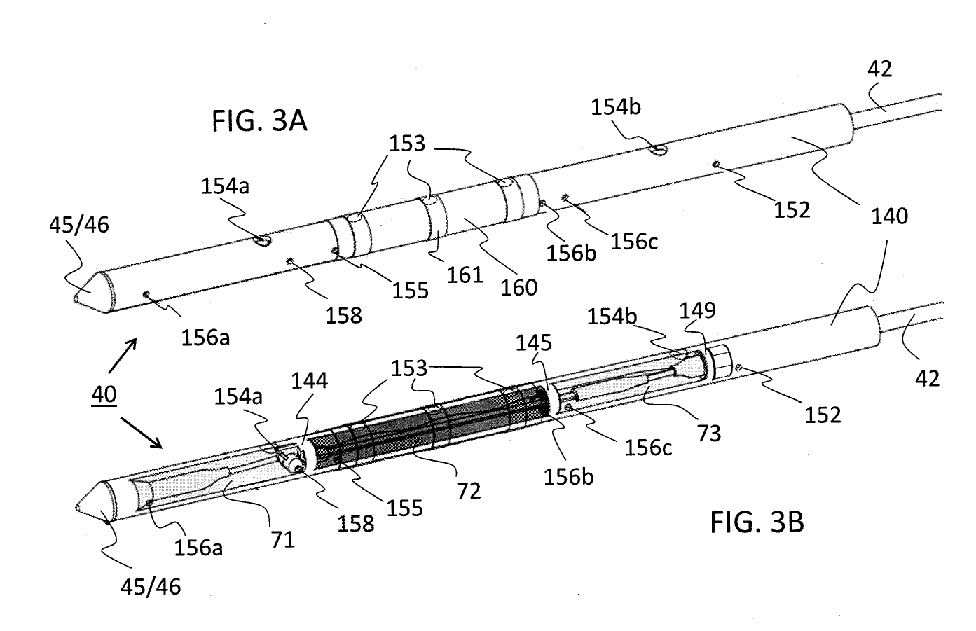

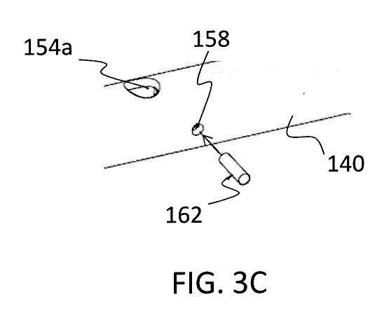

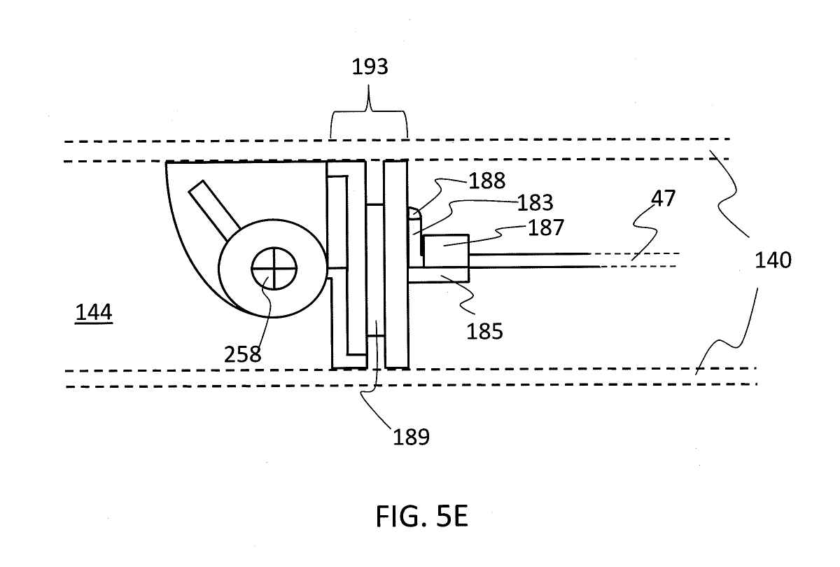

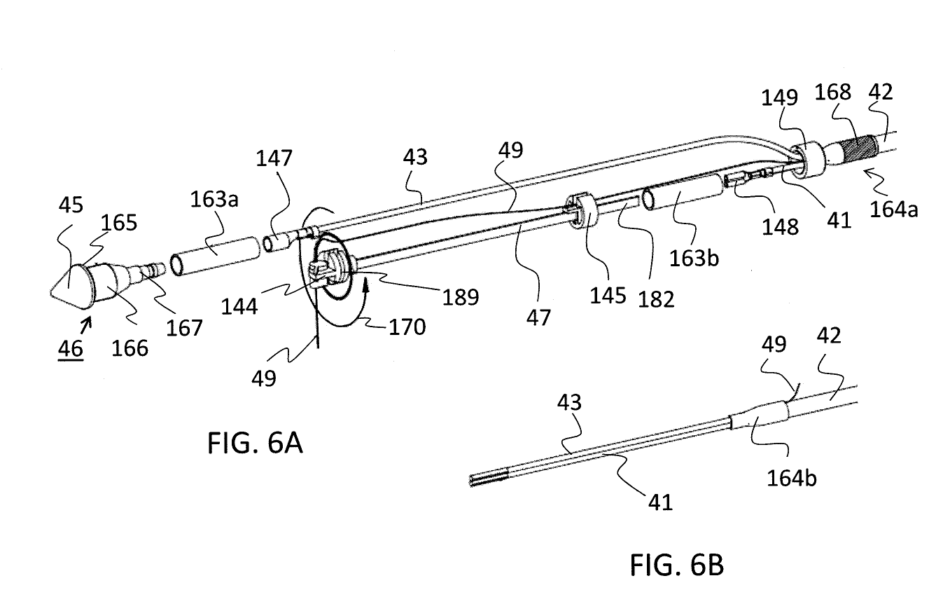

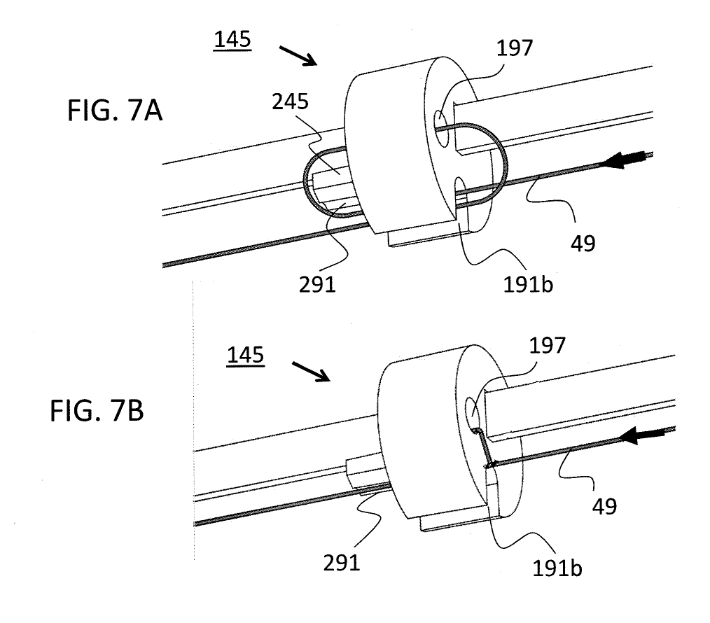

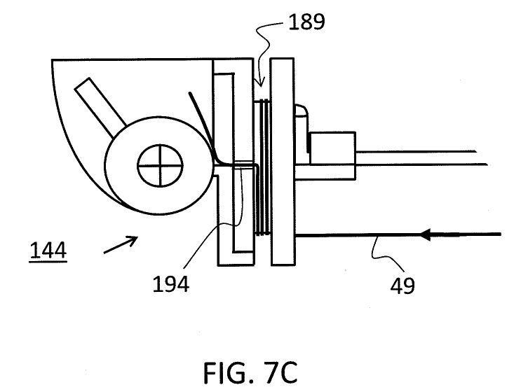

The exemplary stake assembly is inserted into and positioned within protective tube 140 with driving tip/coupon 45/46 forming the driving tip of the stake and dual cable 42 exiting the stake through cable bulkhead 149. Protective tube 140 has a plurality of holes (e.g., 152 and 153, etc.) extending through the tube wall into the cavity of the hollow tube. A plurality of soil contact holes 153 (three are shown) are positioned with respect to the inserted stake assembly to provide mechanical and electrical contact between the porous protective layer 48, electrode 47 encased therein and the surrounding soil. Additional soil contact holes can be provided around the tube. A plurality of water drainage holes 152 (one is shown) are provided to allow water to exit the stake. Additional holes can be provided in the stake as illustrated in FIG. 3A. A length of dual cable 42 exits the stake as illustrated for connection to the potential measurement device. The cable end for this connection is illustrated in FIG. 2C, cables 41 and 43 exit dual cable 42 and the exit point is provided with a seal 162, which can be a water-proof shrink wrap seal. Dual cable 42 is of sufficient length to allow connection to the potential measuring device. FIG. 2C illustrates exiting of optional securing cord 49 which, if present, extends from the stake through dual cable 42. Installation of securing cord 49 in assembly 142 is detailed below in FIGS. 6A, 6B and 7A-C).

In a specific embodiment, protective layer 48 is formed after assembly 142 is inserted and positioned in tube 140 by injection of a clay paste into tube 140 between lower and upper bulkheads 144 and 145 to encase zinc strip electrode 47.

FIGS. 3A-C provide a further detailed illustration of stake 40. FIG. 3A illustrates the outside of the constructed stake ready for insertion into the ground. A number of functional holes are provided in the tube 140 as described below. FIG. 3B illustrates the interior of the stake with assembly 142 inserted. Insertion of the assembly into the tube forms three chambers (71, 72 and 73) within the stake.

Lower stake chamber 71 is formed between the driving tip/coupon (45/46) and lower bulkhead 144. Lower bulkhead 144 fits closely into tube 140 and coupon 46 fits closely into the end of the tube to form the driving tip of the stake. The electrical connection between the coupon and cable 43 is made in chamber 71 via electrical connector 147. Additional insulation is provided over the connector from the coupon to the cable sheath by installing close-fitting electrically-insulating tubing, for example using heat-shrinkable, electrically-insulating tubing. The chamber is filled with curing insulation compound to exclude water and provide insulation of the electrical connection from the soil. Preferably the chamber is completely filled with insulation compound and care is taken to avoid voids and air pockets. In a specific embodiment, injection hole 154a is provided to allow injection of gel insulation, such as silicone. Inspection hole 156a is also optionally provided in chamber 71 to facilitate gel injection and determine completeness of such injection. The position and alignment of lower bulkhead 144 (and assembly 142) within the tube can be set by alignment of the lower bulkhead with locating hole 158. As shown in FIG. 3C, positioning pin 162 can be inserted through locating hole 158 and into a conforming locating hole (258) in lower bulkhead 144 (see also FIG. 7C). After insertion, the positioning pin 162 is preferably flush with the tube wall. Positioning pin 162 can be secured in the locating holes, for example, using an adhesive which can be a cyanoacrylate adhesive.

Upper chamber 73 is formed between upper bulkhead 145 and cable bulkhead 149, both of which fit closely into tube 140. The electrical connection between the reference electrode 47 and cable 41 is made in chamber 71 via electrical connector 147 and the chamber is filled with curing insulation compound to exclude water and provide insulation of the electrical connection from the soil. Preferably the chamber is completely filled with insulation compound and care is taken to avoid voids and air pockets. In a specific embodiment, injection hole 154b is provided to allow injection of gel insulation, such as silicone. Inspection hole 156c is also optionally provided in chamber 73 to facilitate injection of gel injection and determine completeness of injection.

Reference electrode chamber 72 is formed between lower bulkhead 144 and upper bulkhead 145. Chamber 72 contains the reference electrode 47 and the chamber is filled with protective electrolyte 48. A plurality of soil contact holes 153 are provided in the tube which access chamber 72. These holes also allow water to enter the stake to hydrate the protective electrolyte. Three such holes are illustrated in FIG. 3B and additional holes can be distributed around the tube to provide uniform soil contact. In a specific embodiment, protective electrolyte 48 is formed in chamber 72 by injection of a paste of a clay mixture into chamber 72 via injection hole 155. Inspection hole 156b is also optionally provided in chamber 72 to facilitate electrolyte injection and determine completeness of injection. Preferably the chamber is completely filled with protective electrolyte and care is taken to avoid voids and air pockets. In the illustrated embodiment of the stake, soil contact holes are shown covered with a protective cover 160 held in place by fasteners 161, e.g., a cloth cover held in place by tape. Protective cover 160 is preferably installed after assembly of the stake and formation of the protective electrolyte therein to minimize loss of protective electrolyte during transport. The protective cover is removed before installation of the stake. As discussed below, when a clay mixture is employed as the protective electrolyte layer, water is preferably added to the clay prior to, during or after stake installation. Water holes such as 152 can be provided in the upper portion of tube 140 above the cable bulkhead to facilitate additional water drainage from the stake.

Stake tube 40 is made of durable, water-resistant material appropriate for installation underground for extended periods of time. The tube protects the internal elements of the stake during installation and use. In a specific embodiment, the tube is made of a glass fiber weave epoxy composite material. In a specific embodiment, the glass weave composite material has a vertical weave ratio higher than its horizontal weave ratio for increased strength along its length. In a preferred embodiment, the glass weave composite has a vertical weave ratio of 70% and a horizontal weave ratio of 30%.

In a specific embodiment, the lower and upper bulkheads are made of injection-molded, insulating thermoplastic material, particularly polycarbonate.

In specific preferred embodiments, electrical cable of the stake of this invention employs twisted wire to improve attenuation of electrical noise, polypropylene wire sheaths which are immune to water and provide very high insulation resistance, most preferably greater than 1000 Mohms, and black cable jacket polyester which is immune to water and provides protection against UV, abrasion and insect attack.

Zinc is the preferred reference electrode for applications herein as it acts as a stable voltage reference at approximately −1100 mV+/−100 mv with respect to a Cu/CuSO₄ reference half-cell commonly used in the art. In specific embodiments, high purity zinc, preferably 99.99% purity zinc is employed to improve the voltage reference stability. In specific preferred embodiments, the zinc electrode employed conforms to ASTM B418-73 Type II or AS2239 Alloy Z2 requirements.

Protective electrolyte 48 provides good electrical contact between soil and the reference electrode and minimizes passivation of the zinc by salt ions, particularly chloride, which increases voltage stability. In a specific embodiment, the protective electrolyte 48 comprises bentonite and gypsum. In a more specific embodiment, the electrolyte comprises bentonite, gypsum and a sulfate salt. More specifically the sulfate salt is sodium sulfate. The sulfate salt provides increased protection against passivation of the zinc. In specific embodiments, the protective electrolyte comprises 2 to 8 wt. % sodium sulfate. In a more specific embodiment, the protective electrolyte comprises 5 wt. % sodium sulfate. In specific embodiments, the weight ratio of bentonite to gypsum ranges from 3 to 0.33. In other specific embodiments the weight ratio of bentonite to gypsum ranges from 1.4 to 0.7. In other more specific embodiments, the weight ratio of bentonite to gypsum ranges from 1.1 to 0.9. In yet another specific embodiment, the weight ratio of bentonite to gypsum is 1.

In a specific embodiment, protective electrolyte 48 is formed by encasing the metal strip 47 of the reference electrode with a water paste of a mixture of bentonite and gypsum as described above. Specifically, such a water-clay paste can be injected into the stake to encase the electrode. More specifically, such a water-clay paste can be injected into chamber 72 of the stake, illustrated in FIG. 3B, via the injection hole 155 provided. After assembly of the stake and prior to installation in the soil, the clay paste encasing the metal strip is dried to minimize loss of electrolyte during transport and installation. The protective electrolyte is rehydrated prior to installation of the stake on site.

In an alternative embodiment, the reference electrode including metal strip (47) with surrounding clay-based electrolyte (48) can be molded before introduction into the stake. This can be accomplished by inserting the metal strip (47) mounted into upper and lower bulkheads (144 and 149, respectively) into a heat-resistant mold shaped to conform to the internal diameter of tube 140. The mold is then filled with a clay paste, as described herein, and the filled mold is heated at or above 100° C. to dry the clay to a hard yet porous form. In a preferred embodiment, a slot for receiving insulated wire 43 is formed in the mold or otherwise provided in the molded reference electrode.

In an alternative embodiment, the surrounding clay-based electrolyte (48) can be extruded before introduction into the stake. The clay paste, as described herein, is forced at pressure through a die of appropriate form. The extruded section may be cut to the required length either prior, or subsequent, to baking of the paste to dry the clay to a rigid form allowing subsequent handling without damage. The extruded sections may be assembled around the metal strip (47) mounted into upper and lower bulkheads (144 and 149, respectively). In a preferred embodiment, a small quantity of clay paste may be introduced between the extruded forms and the metal strip to ensure electrical connection. In a preferred embodiment, a slot for receiving insulated wire 43 is provided is formed in the extruded section or otherwise provided in the molded reference electrode.

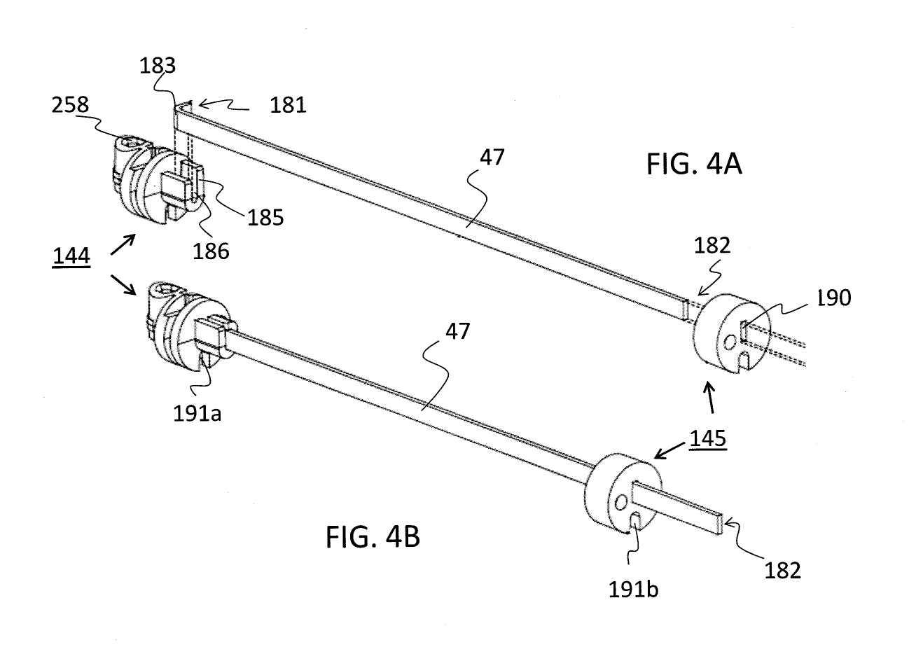

FIGS. 4A and B illustrate more detail of an exemplary stake assembly. Reference electrode 47 is illustrated as an elongated metal sheet or strip having a distal end 181 and a proximal end 182 (with respect to the soil surface on installation of the stake). Distal end 181 is attached to and supported in lower bulkhead 144. In a specific embodiment, lower bulkhead 144 is provided with electrode holder 185 having open slot 186 for receiving distal end 181 (shown with bent distal end 183). Upper bulkhead 145 is provided with through slot 187 (extending longitudinally through the bulkhead) into which the proximal end 182 of the electrode is inserted and supported. Lower bulkhead 144 is optionally provided with locating and alignment hole 258 for receiving optional positioning pin 162 (see FIG. 3C). The proximal end (182) of the electrode extends through upper bulkhead 145 to facilitate connection with electrode connector 148 (see FIG. 2A). The lower and upper bulkheads are optionally provided with cable slots 191a and 191b to allow cable 43 which connects to coupon 46 to pass through the stake.

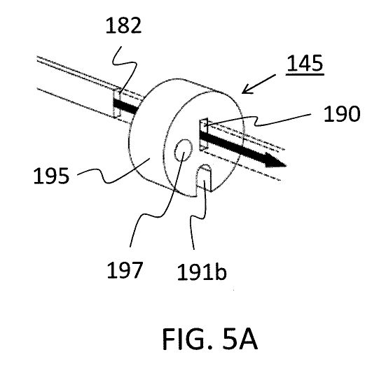

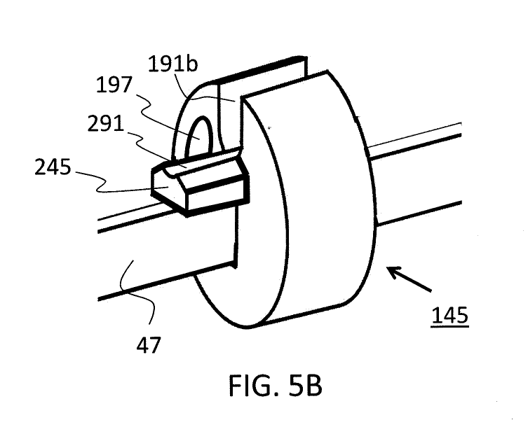

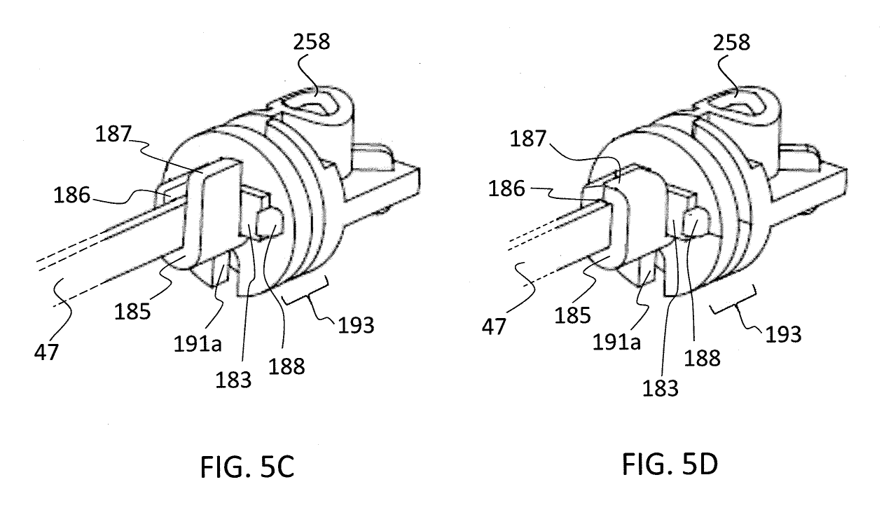

Exemplary upper bulkhead 145 is illustrated in more detail in FIGS. 5A and B. Upper bulkhead 145 has circumferential surface 195 sized for close insertion into tube 140, through slot 190 and through cord hole 197. Through slot 190 is sized and shaped for closely receiving and supporting the proximal end (182) of electrode 47 (see FIGS. 4A and B). Through slot 191b extends longitudinally (direction of insertion of distal end) through the upper bulkhead and is sized and shaped for closely receiving insulated electrical cable 43. Optional through cord hole 197 extends longitudinally through the upper bulkhead to facilitate passage and securing of an optional securing line (described in detail below). In a specific embodiment shown in FIG. 5B, upper bulkhead 145 is provided with guide 245 having cord channel 291 for receiving optional securing cord 49.

Exemplary lower bulkhead 144 is illustrated in more detail in FIGS. 5C-D Lower bulkhead 144 has circumferential surface 193, sized for close insertion into tube 140, locating hole 258, and electrode holder 185 with open slot 186 which is shaped as illustrated to receive the bend (183) at distal end 181 of electrode 47. A portion of a wall of slot 186 is a deformable flap 187 which can be folded over as shown in FIG. 5C to close slot 186 and secure bent distal end 183 in the lower bulkhead. In a specific embodiment, the holder and flap are formed of thermoplastic material and the bent end 183 is secured to the lower bulkhead by heat staking flap 187. FIG. 5E illustrates the lower bulkhead in place within tube 140, where locating hole 258 in the lower bulkhead can be aligned with locating hole 158 in tube 140 and pin 162 can be inserted through hole 158 and into hole 258 to position lower bulkhead 144 and assembly 142 within tube 140 (See FIG. 3C). Lower bulkhead 144 is optionally provided with cord reel 189 which functions to anchor securing cord 49 which is described below.

FIGS. 6A and B illustrate additional details of an exemplary stake assembly 142 of this invention. FIG. 6A illustrates additional details of electrical connection within assembly 142. FIG. 6B illustrates additional details of the dual connector of the stake. Coupon 46 has pointed driving tip 45 with shaft 166 sized to fit closely into the lower end of hollow tube 140 (see FIGS. 2A and B). The diameter of the top of driving tip 45 is larger than that of shaft 166 forming lip 165, such that when inserted into tube 140, lip 165 does not enter tube 140 and driving tip 45 is positioned at the lower end of the stake. Driving tip 45 is secured in tube 140 after insertion of assembly 142, for example, by application of adhesive to shaft 166, which can be a cyanoacrylate adhesive. Shaft 166 ends in electrical connector 167 which is compatible for connection with connector 147 which terminates cable 43. Electrical connector 148 which terminates cable 41 is compatible for connection to the proximal end 182 of electrode 47. Optionally, but preferably, the electrical connection to connectors 147 and 148 are provided with seals 163a and 163b, respectively, which can be water-proof shrink wrap seals. The ends of dual cable 42 can also be provided with seals 164a and 164b, which can be water-proof shrink wrap seals. More specifically herein water-proof shrink wrap seals can be adhesive lined heat-shrinkable polyolefin tubing. As noted above, the proximal ends of cables 43 and 41 (with respect to the soil surface on stake installation) are electrically connected to the potential measuring device 50. Cable 43 which extends through the stake assembly is preferably positioned at edge of the reference electrode cavity close to the tube inner wall and not obscuring the soil contact holes. Additionally, it is preferable that this cable is aligned with the thin edge of the zinc strip. Cable 43 can, for example, be positioned in cable slots 191a and 191b, in the lower and upper bulkheads, respectively, and secured therein, for example using adhesive. In a specific embodiment, adhesive may be employed to secure cable 43 in the lower bulkhead. In a specific embodiment, cable bulkhead 149 is secured to protective seal 164a over dual cable 42, for example, employing adhesive 168, which can be cyanoacrylate adhesive.

In a specific embodiment, once electrode 47 is secured to the lower bulkhead and inserted into the upper bulkhead, securing cord 49 is threaded through the stake assembly, secured at lower bulkhead 144 and upper bulkhead 145, and extended through the length of dual cable 42 where it is secured at protective seal 164b. The cord is pulled taut before securing between the end of the dual cable 42 and the lower bulkhead 144. The securing cord 49, preferably nylon cord, provides substantial resistance to damage to the electrode assembly and electrical connections in the stake assembly. In a specific embodiment, as illustrated in FIGS. 7A and B, securing cord 49 is threaded through the upper bulkhead passing through cable slot 191b and looping back through cord hole 197 and again passing through cable slot 191b. Securing cord 49 is then pulled tight as illustrated in FIG. 7B and can be secured in cable slot 191b with adhesive, for example. Securing cord 49 is then threaded around and secured at lower bulkhead 144. As illustrated in FIG. 7C, securing cord 49 can be secured in the lower bulkhead by looping the cord several times around reel 189, pulling the cord taut through securing slot 194 and fastened therein, for example using adhesive which can be a cyanoacrylate adhesive. Although not shown in FIG. 7C, securing cord 49 preferably passes through a portion of cable slot 191a before being looped around reel 189.

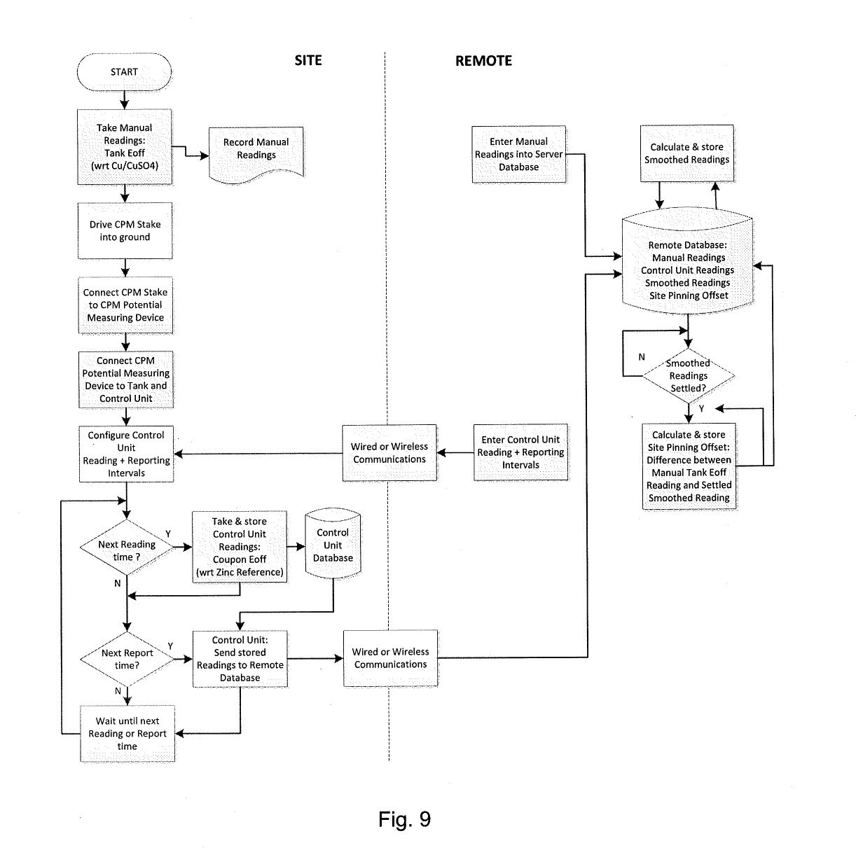

FIG. 9 is a flow chart illustrating additional embodiments of the CP system and methods of this invention. The left side of the flow chart represents steps that take place at the site of the CP system (e.g., where the CP protected structure is buried) which are carried out employing on site components described above. The right side of the flow chart represents remote system components and steps that take place at one or more remote locations.

First the installation of on-site components of the CP system is discussed. The site as exemplified in FIG. 1A has a CP system in place. In the discussion that follows the CP system in place is assumed to be operating properly and to be providing adequate protection to the structure. It will be appreciated that it is beneficial to assess the adequacy of the CP system prior to installation of the CP monitoring system (CPM) of this invention.

The CPM system of this invention can be installed at the site when the CP system is itself installed or the CPM system can be installed at an already existing site, for example, to replace a previous CPM system or to add monitoring to an existing CP system. The CPM system installed on site includes a coupon, reference electrode, potential measurement device, control unit and appropriate electrical connections. At the site, the coupon and reference electrode are positioned underground at a selected location such that the coupon is in the same soil environment as the buried structure and close to the least well-protected region of the structure. During installation, the coupon and reference are electrically connected to the potential measurement device such that the potential difference between the coupon and reference is output by the device. During installation, the coupon is electrically connected to the buried structure and the anode of the CP system, such that the coupon is protected by the CP system. This connection is made through a relay switch which is normally closed and which opens on activation from the control unit. Output from the potential measuring device goes to the control unit. The control unit has one or more microprocessors, a wired or wireless communications interface and other elements as illustrated in FIG. 1B. The specific location of the control unit and potential measuring device at the site is not critical as long as the functions of the components are maintained. The control unit and the potential measuring device may be separate units or may be integrated into a single unit within one or more housings or other protective enclosures. In some cases the CP system and buried structure will have an above-ground protective structure allowing electrical connection to the structure and CP system components. CPM components may be installed in such above-ground structures. In some cases, for example, for buried storage tanks, other monitoring equipment may be in place which includes a wired or wireless communications interface. Such an in place communication system can be employed if desired to provide this function of the control unit.

In a specific embodiment, the coupon and reference electrode are integrated into a single element which is positioned underground at the selected location. More specifically, as described in detail above, the coupon and reference electrode are incorporated into a CPM stake which can be inserted into the soil at a selected position appropriate for positioning the coupon with respect to the protected structure. In a specific embodiment, the CPM stake is manually pushed into the ground or driven into the ground manually using a hammer or similar tool. Any appropriate hand or power tools can be employed to install the CPM stake so long as care is taken to comply with applicable regulations and avoid damage to the stake.

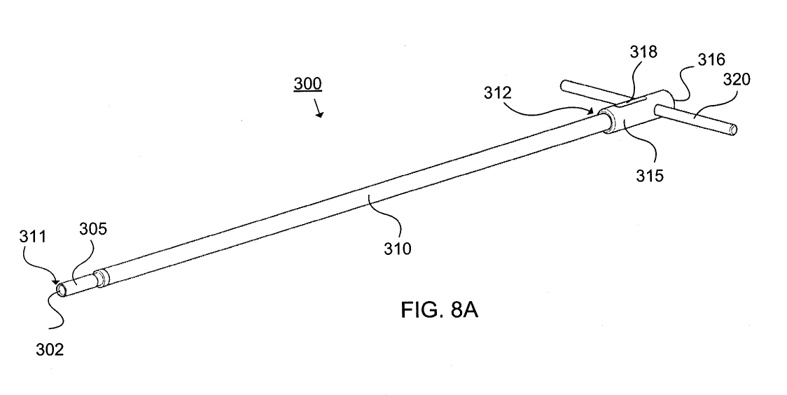

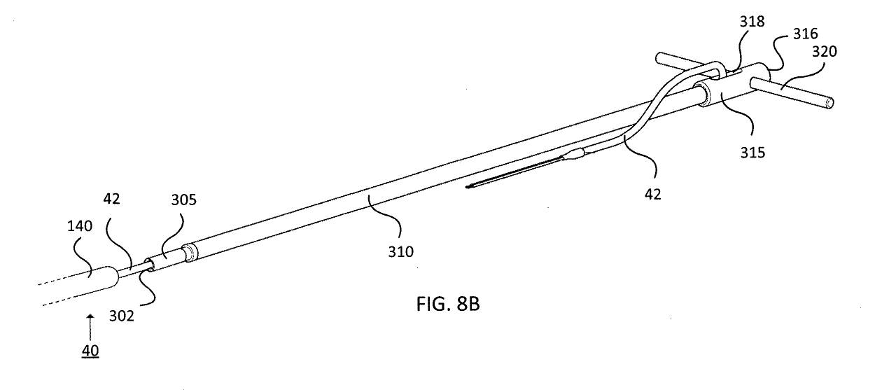

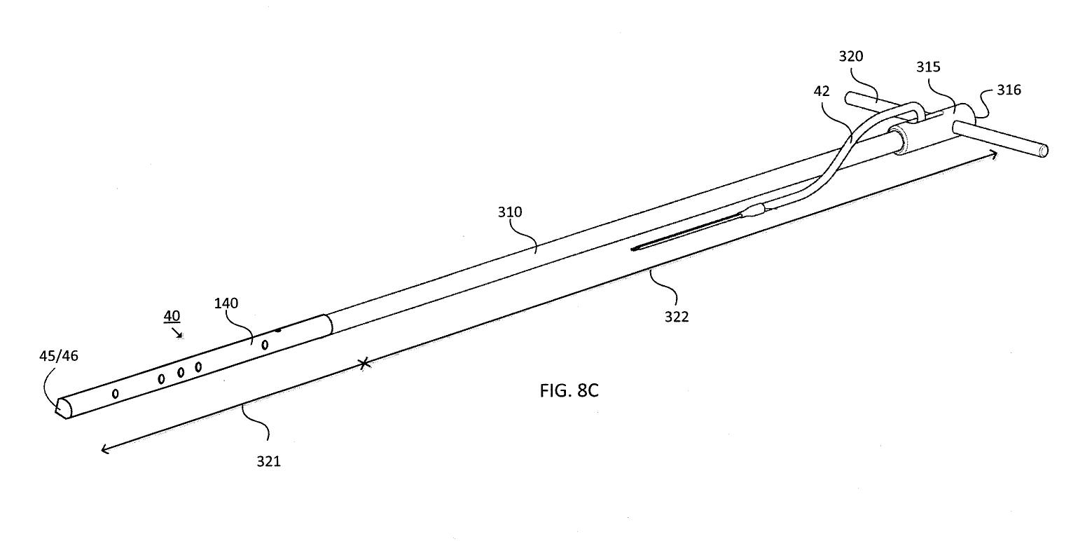

With respect to installation of the CPM stake, in a preferred embodiment, a driver as illustrated in FIGS. 8A and B is employed to position the stake, and more particularly the coupon therein, at a selected depth underground. FIG. 8A illustrates the driver 300, which has a hollow shaft 310 with distal and proximal ends (311 and 312, with respect to the soil surface during installation). At the distal end of the shaft, the outside diameter of the shaft is decreased to form ferrule 305 with outer diameter sized for engaging the proximal hollow end of stake 40. The driver has cap 315 at its proximal end with one or more handles, which is here illustrated as a T-bar 320. The cap has a top driving surface 316 and side opening 318 which communicates with the hollow (302) of shaft 310.

For installation of stake 40, dual cable 42 is threaded into the distal end of shaft hollow 302 of the driver exiting the hollow through cap side opening 318, as shown in FIG. 8B. As was illustrated in FIG. 2C, cables 41 and 43 are within dual cable 42 and after installation of the stake remain above ground for connection to the buried structure and CP anode thought the potential measuring device as described above. Ferrule 305 of the driver is inserted into the hollow of tube 140 of stake 40 during installation of the stake. The combined stake and driver is illustrated in FIG. 8C. The combined length of the stake 321 and the length of the driver 322 is selected to position coupon 46 (which is also driving tip 45 in this figure) at the appropriate depth with respect to the buried structure. The location for installing the stake is chosen based on the size and depth of the structure and on the assessment of the site conditions by one skilled in the art. The stake/driver combination is positioned on the ground surface at the selected distance from the structure and the driver is pushed or driven vertically into the ground, for example using a hammer or mallet on flat surface 316. After the stake is in place, the driver is removed for reuse, releasing cable 42 for making appropriate connections as noted above. In a specific embodiment for application to buried 1-2 kL propane storage tanks the total length of stake and drive is 0.88 m to position the coupon at about the depth of the center line of the tank. In this embodiment, the stake is preferably positioned with 1-5 feet (0.3-1.5 m) from the wall of the tank.

Prior to stake installation, the protective electrolyte of the reference electrolyte is hydrated. This can be accomplished by immersing the stake in water (with water entering via holes 153) or otherwise introducing water into the stake. When the driver is employed to install the stake and prior to withdrawing the driver from the installed stake, additional water is added through side opening 318 to further hydrate the protective electrolyte in the stake as well as the soil surrounding the stake.

Returning to the flow chart of FIG. 9, installation of the CPM system, involves, installation of the stake, electrical connection of the stake components to the CPM potential measuring device and connection of the potential measuring device to the structure and CP anode. In a preferred embodiment, prior to connecting the CPM system, a manual reading of the structure Eoff is taken with respect to a conventional Cu/CuSO₄ reference electrode and recorded. This reading can be employed for later calibration (pinning) of the potential difference measurements which are measured with respect to the reference electrode in the stake (preferably a zinc reference electrode). Preferably after installation of the coupon, a manual reading of Eoff of the coupon and the stake reference electrode is taken with respect to a conventional Cu/CuSO₄ reference electrode and the readings recorded for future use. Additional manual measurements to assess the operation of the CP system can also be taken prior to and/or after CPM system installation. These manual readings can be useful to assess continuing operation of the CP system.

The control unit can be pre-configured with the reading and reporting intervals. Alternatively, after installation, the control unit can be configured remotely via the wired or wireless communication interface. Potential difference measurements are preferably scheduled once a day with reports typically being made once a week. It will be appreciated that the readings and reporting schedule can be reset or changed as desired or needed and in a specific embodiment, such changes can be made remotely via the communications interface of the control unit. The control unit is typically pre-configured with respect to the sampling regime as discussed above. In a specific embodiment, one or more of the microprocessors of the control unit are programmable and their configuration can be reset or changed as needed or desired, particularly remotely via the communications interface of the control unit. In a specific embodiment, a non-scheduled reading or a non-scheduled report can be triggered remotely via the communications interface, if needed or desired.

Operation of the CPM system for taking and reporting potential measurement readings is illustrated on the bottom left of FIG. 9. The system waits for the scheduled time to take a reading. At the scheduled time, the switch 53 is activated by the control unit and the output of the potential measuring device is sampled as described above to obtain an averaged reading. This averaged reading is measured with respect to the reference electrode in the stake, preferably a zinc reference electrode. As illustrated, the averaged reading obtained can be stored in a control unit database in local memory, if desired. The system waits for the scheduled time to report readings taken and at the scheduled time reports all readings associated with the time each reading was taken since the last report. In a specific embodiment, daily readings are taken and stored with reports scheduled once a week. In an alternative embodiment, each reading can be reported directly after it is taken if desired.

The right side of FIG. 9 illustrates components and operations of the CPM system at one or more remote locations. The averaged potential difference readings collected on-site with respect to the stake reference electrode are transmitted and entered into a remote database associated with the time the reading was taken and associated with identifying information for the site/protected structure. In a preferred embodiment, the raw collected data is smoothed, for example, by taking a rolling average of the data over a selected time period, e.g., weekly, biweekly, monthly etc. In a more preferred embodiment, a 30-day rolling average is employed to smooth raw data. One of ordinary skill in the art will appreciate that other data smoothing techniques can be applied without departing from the methods of this invention. Collected data and smoothed data are stored in the remote database. Smoothing of the raw collected data is accomplished employing one or more computer executed programs. It will be appreciated that a variety of computer programs are available to those in the art for data smoothing.

The data (collected and/or smoothed) are monitored over a period of time to ensure that the coupon and stake reference have settled. Settling relates to stabilization of the coupon and stake electrode after installation in soil such that the scheduled potential difference readings between these components stabilize to within a selected acceptable error limit. Stabilization takes place over a period of days or weeks and stabilization time is highly dependent upon the soil type and extant environmental conditions. In a specific embodiment, the potential difference readings are considered to be stabilized when sequential daily readings do not vary more than +/−10 mV. Assessment of settling can be made by an appropriately skilled/trained operator viewing the data or the data can be automatically compared and assessed using any appropriate data analysis program. For many CPM systems of this invention, the value of the settled potential difference can be set based on a standard settling time, e.g., 12-16 weeks, determined by evaluation of settling time in a variety of CPM systems.

In a specific embodiment, the manual readings taken on site with respect to a conventional Cu/CuSO₄ reference electrode are used to calibrate the collected/smoothed potential difference readings once those readings have settled. The value of the settled potential difference, e.g. at an assessed settling point or at a standard settling time, is deemed to be equivalent to the recorded Eoff measurement taken of the buried structure with respect to the conventional Cu/CuSO₄ reference electrode. The potential difference readings can thereafter be calibrated (or pinned) with respect to the conventional Cu/CuSO₄ reference electrode. Assessments of the level of protection can thereafter be made based on conventional standards which were established employing conventional Cu/CuSO₄ reference electrodes.

Collected potential difference data is stored in the remote database along with associated protected structure information and optionally manual potential measurements taken on site. The collected data is employed to assess protection status of a given structure (e.g., a storage tank) by its CP system. Protection state of a given protected structure is determined by a comparison of stabilized, collected data with respect to pre-set potential limits known (or determined) to be indicative of protection state. In a specific embodiment, at least four protection states are described: protected, unprotected, marginally protected and overprotected based on comparison of collected data with pre-set potential limits. Additional protection states can be assigned as are needed or found to be useful. For example, a protection state of “unknown” can be assigned for sites where data has not yet stabilized or there is some system fault. Protection state of a given protected structure can be assessed at any selected time automatically by a computer-implemented process. In a preferred embodiment, any automated assessment of protection state or any change in protection state is reviewed and confirmed by a skilled/trained operator. In this case, additional confirmed protection states can be assigned to those sites where, for example, protection state has been confirmed and accepted, confirmed and found to be incorrect or simply awaiting review. The pre-set potential limits which define protection state can be changed or adjusted. Such changes may be made for example to meet the a customer's notification needs or to better reflect the correlation of coupon potential measurement with protection state which may be gained over time at a given site. Care should be taken however that any changes are consistent with local regulations governing CP systems and monitoring in a given application. The collected data, smoothed and/or calibrated data and protection state can be displayed in any convenient display format. For example, as noted above the collected, smoothed and calibrated data can be stored in any appropriate database for the generation of numerical or graphical presentation. Data reports can be provided to customers in any convenient numerical or graphical format. In a specific embodiment, a customer may be provided with on-demand access to reports for one or more CP system sites via a secure web site. As an alternative, a customer may simply be provided with a report by any available communication method. For example, data may be displayed as a graph of readings (collected, smoothed and/or calibrated) as a function of time with under protection and overprotection limits provided for comparison. In addition to collected data, a customer may be advised of any alarm condition that has been transmitted from the site. Alarms may be communicated to a system operator and/or customer by any appropriate method, including by electronic mail, text message or cell phone.

The remote location can be a central database, which is operationally linked to one or more computers, and which handles CPM for a number of customers and generates reports or displays of that data and any alarm conditions for each of the customers. Alternatively, the remote location may be a database which handles CPM for a single customer and to which the single customer (and any system operator) has on-demand access.

In a specific embodiment, the CP monitoring system of this invention provides a reporting or customer interface which can be accessed by the customer and by a system operator (which may in some cases also be the customer.) More specifically, the customer interface provides secured access to collected data and protection state assessment. This interface may also provide access, preferably limited to system operators or skilled/trained customers, to assess stabilization of data, to perform data smoothing, to perform data calibration, to change pre-set potential limits defining protection states, to define additional protection states, to change any pre-set alarm conditions or add new alarm condition. The interface may be provided with different security levels governing access to data processing and or analysis and changing of pre-set limits.

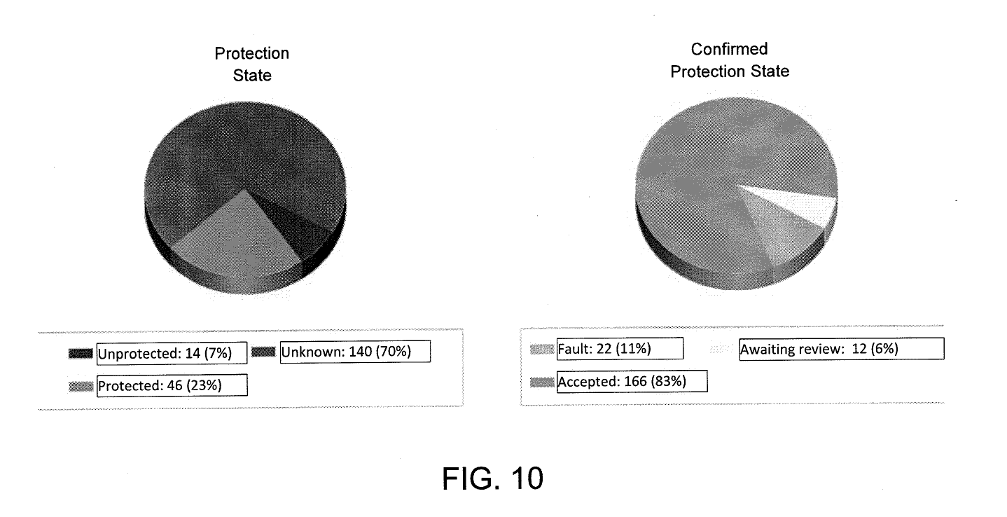

In a specific embodiment, the CP monitoring system generates a summary report, preferably in graphic form, of protection status of one or more protected structures. An exemplary graphical report which is particularly useful to provide an overview of protection state of a plurality of protected structures is illustrated in FIG. 10. The color-coded pie chart on the left summarizes protection state of a selected set of protected structures (a total of 200 sites is included) where protection state is automatically generated based on collected data and pre-set potential limits. In this example, the protection states included are protected, unprotected or unknown (marginal protection is not specifically illustrated but, if present, would be indicated as another category on the pie-chart). The color-coded pie chart on the right summarizes the level of reliability of the protection state assessments made automatically as assessed by a skilled/trained operator reviewing the collected data. Reliability of protection state is indicated as “accepted” (where the protection state assessment is deemed correct), “fault” (where the protection state assessment is deemed incorrect) or “awaiting review” (where the protection state has not as yet been reviewed). A report such as that shown in FIG. 10 can, for example, be made available to the system operator and/or customer via an interactive web site which can be additionally configured to provide additional details of the protection state of any given site among those included in the summary.

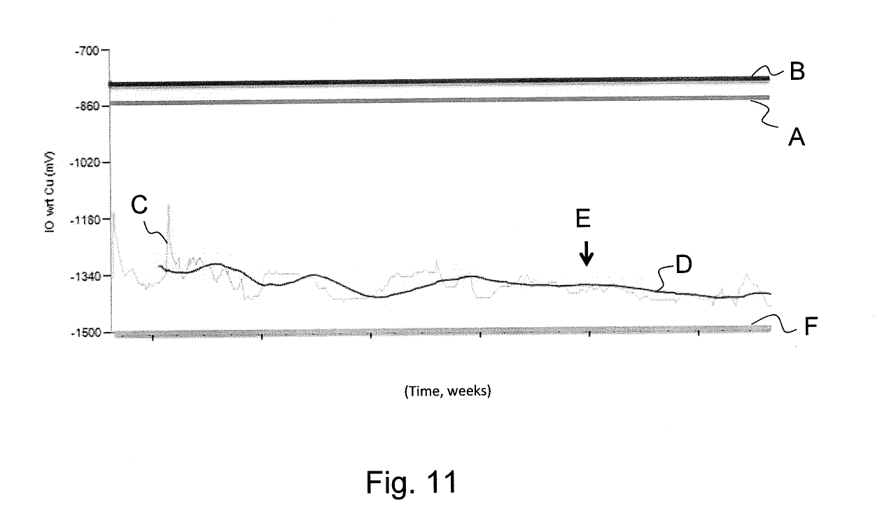

In another specific embodiment, the CP monitoring system generates a historical graph of collected data as a function of time as illustrated in FIG. 11. The graph plots potential difference calibrated with respect to a Cu/CuSO₄ reference electrode as a function of time. Lines A and B are pre-set voltage limits indicative of protection status. A potential difference less negative than that of B is “unprotected” and a potential difference more negative than A is “protected.” Also included in the graph is line F which represents the limit for overprotection, such that a potential difference more negative than this limit is overprotected. A potential difference between A and B is categorized as “marginal.” In the illustrated embodiment, the A limit is set at −850 mV, the B limit is set at −800 mV and the F limit is set at −1500 mV with respect to the Cu/CuSO₄ reference electrode. The graph plots potential difference data C beginning on installation of the CP monitoring system. As data accumulate, the data can be smoothed, for example using a 30 day-rolling average process, as illustrated by D. The point at which the coupon and stake were assessed to be stabilized is indicated at point E, about 4 months after installation. After this point, the potential difference measurements (with respect to the Zn reference electrode) can be calibrated to the measurement taken on site with respect to the Cu/CuSO₄ reference electrode. A report such as that shown in FIG. 11 can, for example, be made available to the system operator and/or customer via an interactive web site which can be additionally configured to provide additional details of the protection state of any given site among those included in the summary.

Additional reports including, among others, lists of sites with different protection states, installation and location information, and lists of settings used in data processing and interpretation can also be provided. The customer interface can optionally provide for the generation of additional reports which can include sorting functions to facilitate oversight and management of CP monitoring and CP systems. The customer interface can also provide a logging function that tracks CP monitoring events, such as stabilization date, calibration date, changes in protection state at any given site, changes in the confirmed protection state, and more generally note access to the interface and note any settings changes that are made by a customer and/or the system operator.

Every combination of components described or exemplified herein can be used to practice the invention, unless otherwise stated. One of ordinary skill in the art will appreciate that methods, device elements, and materials other than those specifically exemplified can be employed in the practice of the invention without resort to undue experimentation. All art-known functional equivalents, of any such methods, device elements, and materials are intended to be included in this invention. Whenever a range is given in the specification, for example, a temperature range, a frequency range, a time range, or a composition range, all intermediate ranges and all sub ranges, as well as all individual values included in the ranges given are intended to be included in the disclosure. Any one or more individual members of a range or group disclosed herein can be excluded from a claim of this invention. The invention illustratively described herein suitably may be practiced in the absence of any element or elements, limitation or limitations which is not specifically disclosed herein.

Each reference cited herein is hereby incorporated by reference in its entirety. However, if any inconsistency arises between a cited reference and the present disclosure, the present disclosure takes precedence. Some references provided herein are incorporated by reference to provide additional or alternative device elements, additional or alternative materials, and additional or alternative methods of analysis or application of the invention. All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

Although the description herein contains the recitation of many specific details, these should not be construed as limiting the scope of the invention, but as merely providing illustrations of some of the embodiments of the invention. One of ordinary skill in the art will appreciate that device elements, as well as materials, shapes and dimensions of device elements, as well as methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

1. A method for monitoring the effectiveness of a cathodic protection system of an underground metal structure which comprises:
positioning a metal coupon and an in situ reference electrode underground at a predetermined position with respect to structure, wherein the metal coupon and in situ reference electrode are integrated into a stake, wherein the metal coupon and reference electrode are separated from each other by a selected distance, the stake facilitating positioning of the metal coupon and reference electrode from above ground with respect to the underground structure and electrically connecting the structure to the metal coupon;
measuring the potential difference between the metal coupon and the in situ reference electrode; and
repeating potential difference measuring on a selected measurement schedule to monitor the effectiveness of the cathodic protection system.

2. The method of claim 1 wherein the structure is electrically connected to the metal coupon through an electrical switch which opens on activation to disconnect the metal coupon from the structure and wherein the switch is activated to open only when a potential measurement is being taken.

3. The method of claim 1 wherein measuring the potential difference between the metal coupon and the in situ reference electrode comprises averaging a plurality of potential measurements over a selected time interval and storing the average measured potential difference.

4. The method of claim 1 wherein a voltage output proportional to the potential difference between the metal coupon and the in situ reference electrode is measured.

5. The method of claim 4 wherein the voltage output is passage through a low pass filter.

6. The method of claim 4 wherein measure potential differences are transmitted for storage in a remote database.

7. The method of claim 1 wherein the in situ reference electrode is an electrode other than a Cu/CuSO₄ electrode.

8. The method of claim 1 wherein the in situ electrode is a Zn reference electrode.

9. The method of claim 1 wherein a calibration measurement is taken on-site prior to positioning of the stake which measures the potential difference between the structure and the a Cu/CuSO₄ reference electrode.

10. The method of claim 9 wherein a calibration measurement is taken on-site prior to positioning of the stake which measures the potential difference between the structure and a Cu/CuSO₄ reference electrode when the structure is disconnected from any sacrificial anode or impressed current system.

11. The method of claim 1 further comprising monitoring measured potential difference measurements to determine that the measured data has settled or stabilized.

12. The method of claim 11 wherein the determination that the measured data has settled or stabilized is performed by a computer-implemented process or by monitoring by a skilled/trained operator.

13. The method of claim 12 wherein any computer-implemented process for determination that data has settled or stabilized is confirmed by a skilled/trained operator.

14. The method of claim 10 wherein after the measured potential data has settled, the calibration measurement taken on-site is used to calibrate the measured potential differences with respect to the Cu/CuSO₄ reference electrode.

15. The method of claim 14 further comprising providing a report of potential difference measurements or calibrated potential difference measurements as a function of time from installation of the stake.

16. The method of claim 14 further comprising assessing the protection state of the structure by comparing the calibrated potential difference to pre-set potential limits know to be indicative of protection state.

17. A CP monitoring system for an underground metal structure which comprises:
(a) metal coupon and an in situ reference electrode underground at a predetermined position with respect to structure, wherein the metal coupon and in situ reference electrode are integrated into a stake, wherein the metal coupon and reference electrode are separated from each other by a selected distance, the stake facilitating positioning of the metal coupon and reference electrode from above ground with respect to the underground structure and electrically connecting the structure to the metal coupon;
(b) a potential measurement device to which the structure, metal coupon and in situ reference electrode are electrically connected such that the potential difference between the coupon and the in situ reference electrode can be measured; and
(c) a control unit which provides power to take potential measurements, controls timing of potential measurements, averages potential difference measurements and transmits the averaged potential difference measurements to a remote database.

18. The CP monitoring system of claim 17 wherein the structure is electrically connected to the metal coupon through an electrical switch which opens on activation to disconnect the metal coupon from the structure and wherein the switch is activated to open only when a potential measurement is being taken.

19. The CP monitoring system of claim 17 further comprising a user interface for accessing transmitted averaged potential difference measurements from the remote database.

20. The CP monitoring system of claim 17 further comprising one or more computer systems for processing and analyzing transmitted averaged potential difference measurements.

21. The CP monitoring system of claim 17 wherein the in situ reference electrode comprises a zinc metal strip encased in a protective electrolyte comprising gypsum, bentonite and sulfate ion.

22. The CP monitoring system of claim 17 wherein the stake comprises a reinforced plastic tube with a driving tip with the coupon and in situ reference electrode contained within the tube such that, when the stake is installed, the coupon and reference electrode are in mechanical and electrical contact with the surrounding soil.

23. The CP monitoring system of claim 17 wherein the driving tip of the stake is the coupon.

24. A CP monitoring system component which comprises a coupon and an in situ electrode for measurement of the potential difference between the coupon and the reference electrode for installation in the vicinity of an underground structure protected by a CP system wherein the coupon and in situ electrode are integrated and contained within a reinforced plastic tube forming a stake such that, the coupon and in situ reference electrode are electrically insulated from each other in the tube, but the coupon and reference electrode are in mechanical and electrical contact with the surrounding soil when the stake is installed in the ground and further comprising electrical cable for electrically connecting the coupon to the underground structure and electrically connecting the in situ electrode such that the potential difference between the coupon and in situ reference electrode can be measured.

25. The component of claim 24 wherein the in situ reference electrode comprises a zinc metal strip encased in a protective electrolyte comprising gypsum, bentonite and sulfate ion.

26. The CP component of claim 24 further comprising a driver to facilitate installation of the stake having a hollow shaft and a cap with a driving surface, the hollow shaft having a distal and proximal end, the cap positioned at the proximal end of the shaft, wherein the stake and electrical cable thereof is received in the distal end of the shaft and the electrical cable exits the proximal end of the shaft below the cap.
